(19) United States
(12) Patent Application Publication
(10) Pub. No.: US 2017/0222219 A1
(43) Pub. Date: Aug. 3, 2017

(54) ORDERED NANO-POROUS CARBON COATING ON SILICON OR SILICON/GRAPHENE COMPOSITES AS LITHIUM ION BATTERY ANODE MATERIALS

(71) Applicant: Dong Sun, Arcadia, CA (US)

(72) Inventor: Dong Sun, Arcadia, CA (US)

(21) Appl. No.: 15/008,639

(22) Filed: Jan. 28, 2016

(51) Int. Cl. H01M 4/36; H01M 4/134; H01M 4/133; H01M 4/04; H01M 4/1393; H01M 4/38; H01M 4/583; H01M 10/0525; H01M 4/1395

(52) U.S. Cl. CPC H01M 4/366; H01M 10/0525; H01M 4/134; H01M 4/133; H01M 4/1395; H01M 4/1393; H01M 4/386; H01M 4/583; H01M 4/0428; H01M 4/0402; H01M 4/0471; H01M 2004/027

(57) ABSTRACT

The present invention provides high specific capacity composite anode materials of silicon and carbon with stable charge/discharge cycling performance, and methods of producing them, where the composite anode materials comprise a core of silicon particles or silicon/graphene hybrid, and a layer of nano-ordered porous carbon coated on its surface. The coated carbon layer was produced by pyrolysis of self-assembled composite of a co-block polymer and a phenolic resin which was prepared from formaldehyde and phenolic compounds with either an acid or base as a catalyst.

### FIELD OF THE INVENTION

This disclosure relates to active lithium ion battery anode materials and lithium ion battery.

### BACKGROUND OF THE INVENTION

Since the introduction to commercial market by Sony inc. in the early 1990s, the rechargeable lithium ion battery (LIB), an electrochemical energy storage device composed of a cathode, an anode, a separator, and electrolyte, has become the dominant power source for portable electronics. The state of art LIB technology applies carbonaceous materials, natural or synthetic graphites, as the active component in the anode. However, the relatively low specific capacity of graphite (theoretical 372 mAh/g, LiC₆ when lithiated) cannot meet the ever increasing demand of energy density for long lasting operation of these electronic devices. The emerging and soon will-be popular electric vehicles (EVs) and hybrid EVs demand even higher energy density than the current LIB technology can offer. LIB is considered as the technical bottle-neck of EVs from the aspects both of energy storage capability and cost.

Silicon, cheap and abundant on Earth, was long considered and studied as the viable replacement for graphite anode material due to its high specific capacity, which is almost ten times of graphite (4200 mAh/g), and low potential when lithiated, which is similar to graphite. The lithiation mechanism of silicon reacting with lithium is however, quite different from that of graphite: lithiation/delithiation of graphite is an intercalation/deintercalation process, while lithiation of silicon is an alloying process in which all or partial of the Si—Si covalent bonds are broken, thus accompanying the lithiation/delithiation process is a huge volume change (>300%). The huge volume expansion/contraction causes several technical challenges for silicon to be applied as anode material in LIB: 1) silicon particles are pulverized to generate many smaller particles and increase surface area many folds; 2) the SEI formed on silicon particles by the reactions between the electrolyte and the lithiated silicon was unable to accommodate the huge volume change, it ruptures/reforms constantly as charge/discharge cycling continues, thus it is unstable and consumes electrolyte during every cycling to cause electrolyte “dry-out”; 3) the pulverization and recrystallization of silicon particles during cycling also result in the loss of electric contact of some active materials which leads to a deteriorated electrochemical behavior of the anode.

Attempts to overcome these technical difficulties of silicon being applied as active anode material in LIB can be categorized mainly on two methods: 1) nanosizing the silicon; 2) carbon coating the silicon particles. It was demonstrated that as the silicon being nano-sized to a critical dimension, the particles can sustain its size and shape during the lithiation/delithiation process, and the electrochemical performance, such as capacity retention, has been much improved. However, these exotic silicon nano-structures are costly and difficult to scale-up to produce, thus it is inapplicable to LIB industry. The carbon coating method is relatively cheap and easy to operate. The coated carbon layer provides an electronic conducting pathway as well as a substrate for SEI to grow instead of direct onto silicon surface. It also serves as a structural support to confine the volume expansion somehow to some degree. On the other hand, the performance of the anode depends heavily on the completeness or perfectness of the carbon coating. A perfect conformal carbon coating actually leads to a long activation of the silicon to reach its maximum specific capacity because the process of lithium ion penetration to the inside of the carbon shell is very slow if not blocked, and that is unacceptable in real cell design; an imperfect coating with uncontrollable cracks and pores in the coating layer of carbon leads to a fast capacity decay, possibly because some cracks are so big that the SEI is formed on silicon surface. In some cases, that the specific capacity of the silicon/carbon composite drops dead quickly after certain number of cycles which is likely due to the break of the carbon cage as the volume expanded during cycling, indicates that the issue of volume change cannot be solved solely by carbon coating. Thus a buffer space inside the carbon coating layer has to be created to accommodate the volume expansion and keep the coating layer intact during the cycling.

Several methods to create empty space in silicon/carbon composite are worthy of mentioning. One of them is to oxide the silicon surface to form a layer of silicon oxide outside the silicon core, and which was later etched away after carbon coating, but the conformal carbon coating still leads to long activation of silicon nevertheless a good retention of capacity (see, for example, N. Liu et al, Nat. Nanotechnol., 2014, 99, 187-192,); Another method is to prepare a composite made of silicon nanoparticles and graphene sheet in which the silicon nanoparticles is physically mixed with and trapped inside the graphene sheets (see, for example, X. Zhao, et al, ACS Nano., 2011, 5, 8739-8749). The graphene sheets serve as electric conducting network and the voids between the sheets serve as the buffer space for silicon volume expansion, however, the robustness of the composite structure cannot be retained during the cycling, thus a fast decay of capacity was unavoidable.

### BRIEF SUMMARY OF THE INVENTION

The present invention provides high-energy density composite anodes of lithium ion battery with fast lithium ion conducting pathway and structural confinement support for lithium ion battery, and the methods to produce them. The anode material comprises a core of silicon or its composite as the active material and a porous carbon shell as a coating layer. While the present invention is not limited by the disclosed embodiments, many aspects of the invention may be appreciated by the examples discussed in the context.

In one of the embodiments disclosed in this invention the active material as the core of the high energy anode for LIB is silicon particulate with an oxide layer, including but not limiting to nanosize or microsize. The oxide layer was etched away after porous carbon coating.

In another embodiment disclosed in this invention the active material as the core of the high energy anode is silicon composite with conducting carbonaceous materials with flexible layer structures, including but not limiting to graphene and graphene oxides.

In another embodiment the disclosed method of preparation of silicon/graphene composite includes, but not limits to, chemical vapor deposition of silicon nanoparticles onto graphene or graphene oxide surface.

In another embodiment the disclosed method of preparation of silicon/graphene composite includes, but not limits to, mechanical mixing of silicon particles and graphene or graphene oxide.

In another embodiment disclosed in this invention the graphene oxide is being reduced to graphene via thermal reduction at temperatures above 500° C. with H₂/Ar mixed gas.

In another embodiment the porous coating layer on the surface of active anode core is carbon with well-ordered nano-pores.

In another embodiment of this invention the disclosed method is a sol-gel coating process of the well-ordered nano-structured organic composite comprising of a co-block polymer and phenolic resin on the surface of silicon particles or silicon/graphene composite.

In another embodiment the co-block polymer includes but not limits to di-block co-polymers, tri-block co-polymers, or oligomers which serves as structural directing agent during the self-assembly, and the phenolic resin is made from condensation reaction between formaldehyde and a phenolic compound, including but not limited to resorcinol, catechol, and phloroglucinol. The catalyst is either an acid or a base.

In another embodiment the coated organic layer is pyrolyzed at raised temperatures above 400° C. to form a layer of carbon with well-ordered nano-pores. The pore size in the carbon coating layer is preferred to be 2-50 nanometers.

### BRIEF DESCRIPTION OF THE DRAWINGS

FIG. 1. The schemes of the preparation of the high energy anode materials are presented. The silicon particle with an oxide layer or Si/graphene composite is mixed with co-polymer, formaldehyde, and a phenolic compound in water. Formaldehyde and the phenolic compound undergo a condensation reaction catalyzed by an acid or a base to form a resin with co-polymer incorporated inside. The co-polymer/phenolic-resin composite coats the surface of the active material to form a core/shell structure. After pyrolysis at high temperature, a carbon coating layer forms on the surface of the core of the active material with well-ordered nano-pores, as shown on the right.

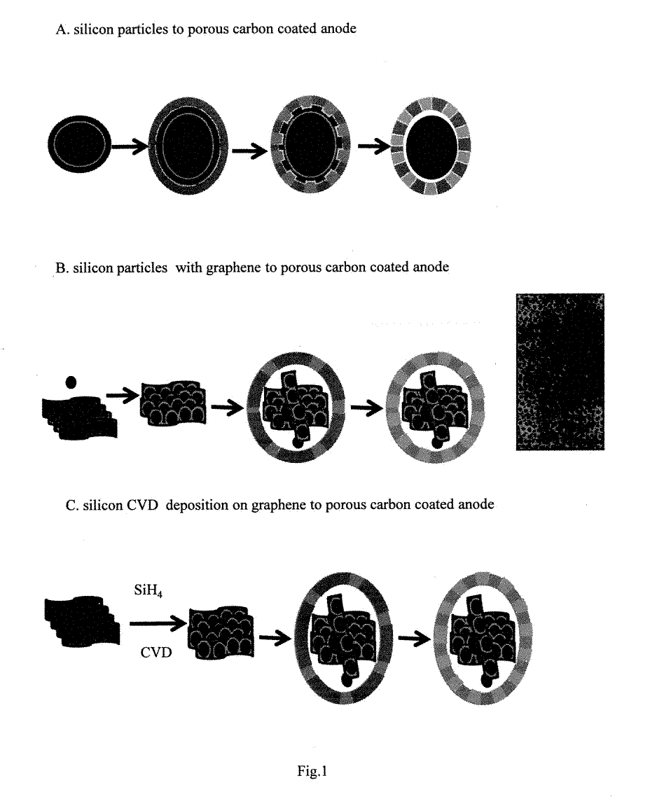

FIG. 2. The TEM image of the Si/graphene composite from chemical vapor deposition. The silicon nanoparticles are shown as black dots with diameter ranged from 5-10 nanometers. These silicon nanoparticles are well separated from each other.

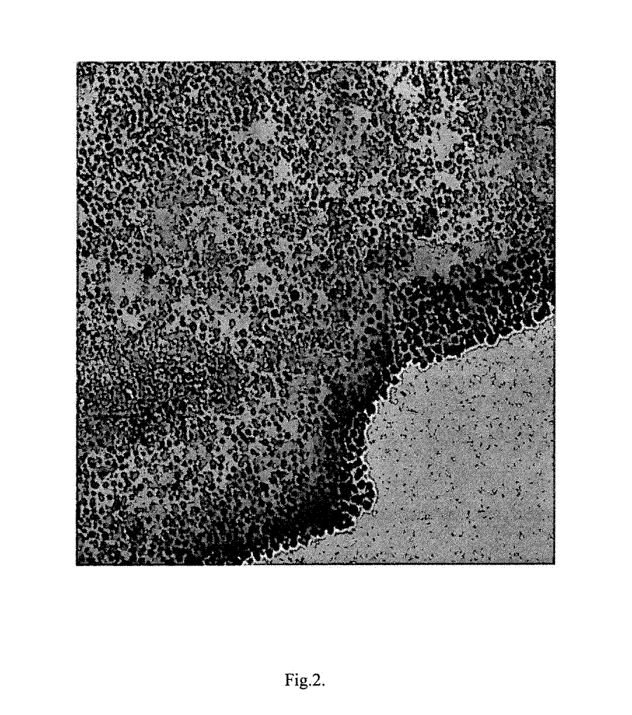

FIG. 3. The SEM image of the Si/graphene oxide composite by physical mixing. In this Figure, silicon nanoparticles and graphene are clearly seen. The silicon nanoparticles are packed inside the graphene sheets and they are stacked together.

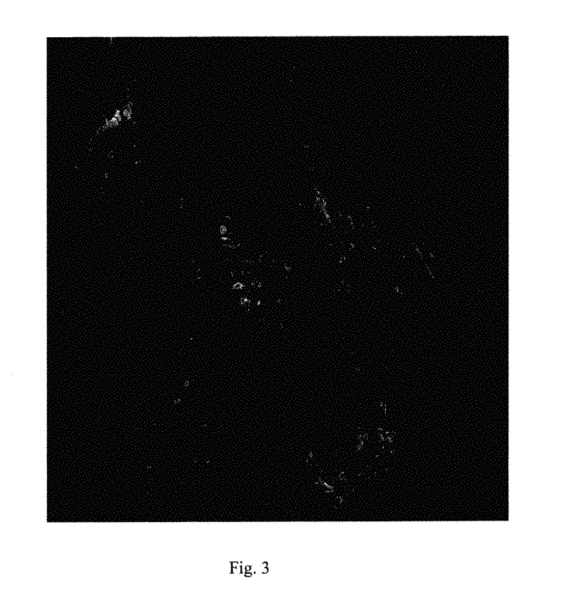

FIG. 4. The XRD of the Si/graphene composite. The XRD pattern shows the diffractions from silicon nanoparticles and graphene.

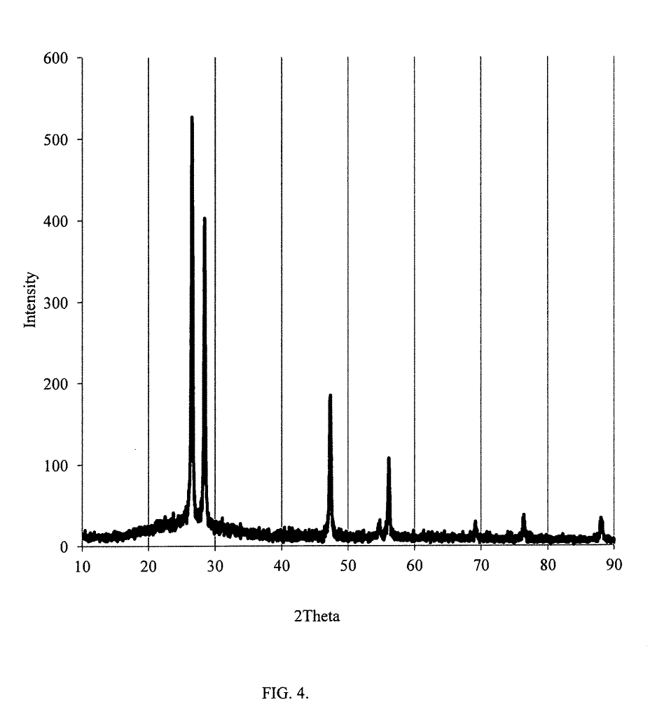

FIG. 5. The BET surface area of Si/graphene coated with nano-porous carbon layer.

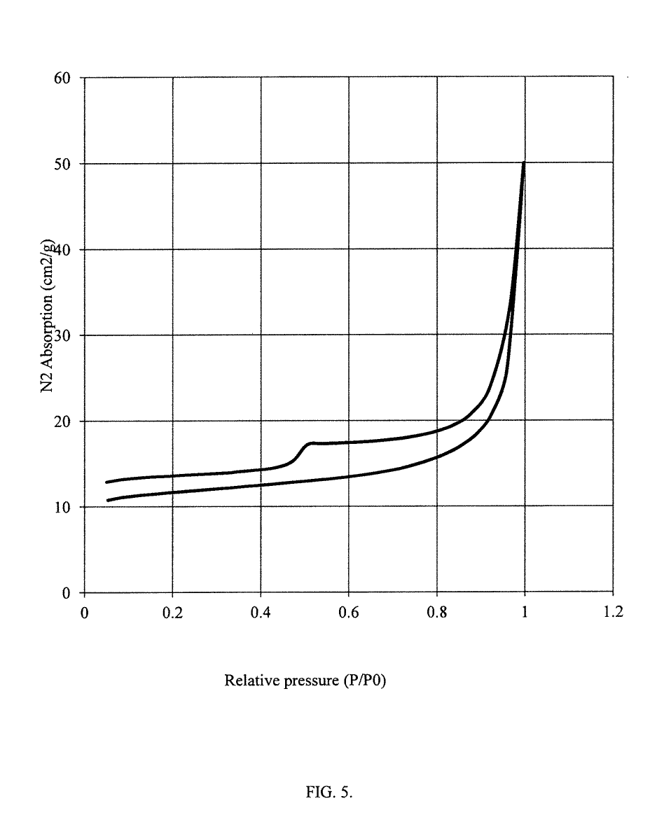

FIG. 6. The cycling performance of silicon/graphene composite anode with a nano-porous carbon coating layer. The activation process of the carbon coated silicon/graphene anode is not observed in this material due to the fast lithium ion conducting pathway via the nano-pores in the coating layer. The capacity decay rate is less than 0.1%.

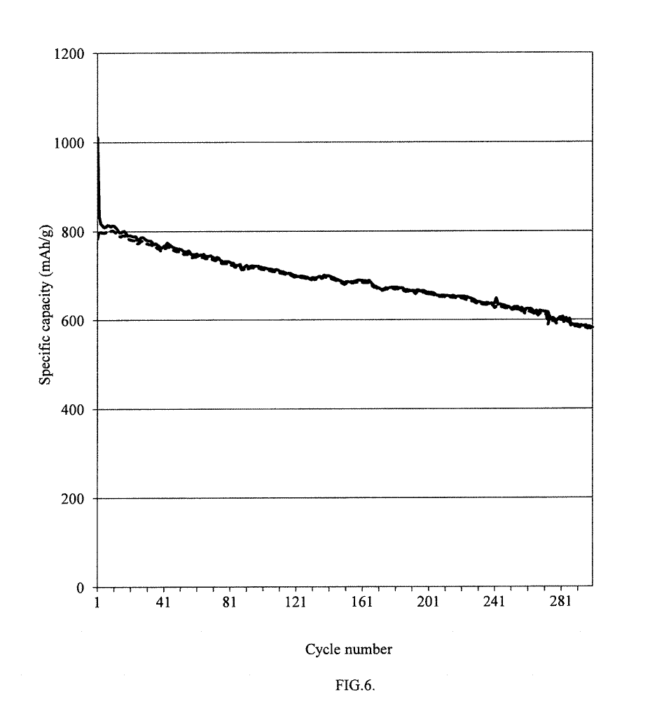

### DETAILED DESCRIPTIONS

The present invention provides high energy density anode materials with silicon as the active component for lithium ion battery and methods to produce them. The proposed anode materials with well-ordered nano-pores in the carbon coating layer are designed to overcome the technical challenges with silicon as active material for lithium ion battery: the huge volume expansion/shrinkage during lithiation/delithiation, and the disadvantages resulted from it. The past methods to solve these technical issues led to the carbon coating of the silicon nano-particles which alleviates these issues but causes a long activation cycling due to the blocked lithium ion conducting pathways. The proposed materials are designed to have voids inside the carbon coating layer to accommodate the volume change of silicon during lithiation/delithiation, and well-ordered nano-pores in the carbon coating layer to ensure fast lithium ion transfer to the silicon inside. In some embodiments, graphene is incorporated in the structure in which it severs as electronic conducting media and the voids between the graphene sheets provide buffer space to accommodate silicon volume change during cycling.

According to one embodiment disclosed in this invention the core of the active material of the high energy anode is silicon particulate with an oxide layer. The particles can be nanosizes or microsizes. The thickness of the oxide layer is preferred to be 10% to 80% of the radius of the particles. The weight of silicon is preferred to be 5% to 80% of the total weight of the anode material, i.e. the weight of the porous carbon layer is 95% to 20% of the total weight. The coated carbon layer is preferred to be few nanometers up to micrometers and the pore size in the carbon coating layer is preferred to be 2 nanometers to 50 nanometers.

According to one embodiment disclosed in this invention the active material as the core of the high energy anode is silicon composite with conducting carbonaceous materials with flexible layer structures. The silicon particles imbedded inside the flexible layer structured substrate is preferred to be nanosize, from 2 nanometers up to several hundred nanometers. The flexible layer structured substrate is preferred to, included but not limited to, graphene or graphene oxide. The weight of silicon nanoparticles is preferred to be 5% to 60% of the silicon composite. The coated carbon layer is preferred to be in nanometers with its weight to be 5% to 50% of the total weight, and the pore size in the carbon coating layer is preferred to be 2 nanometers to 50 nanometers.

According to embodiments of this invention the well-ordered nano-porous carbon coating layer encapsulating the core active anode material can be produced in two steps: 1) sol-gel coating of an organic composite comprised of co-polymer and phenolic resin on the surface of the core of the active anode materials; 2) pyrolyze at raised temperatures the organic composite coated core material to generate a well-ordered nano-porous carbon coating.

Phenol or a phenolic compound can be catalyzed by an acid or a base to react with formaldehyde via condensation to form a phenolic resin. With the presence of structural directing agent, a gel-like organic composite with well-ordered nano domains can be produced. The gel composite is coated on to surface of the core of the anode material to form a capsulate. The structural directing agent is a co-block polymer with polyethylene oxide and polypropylene oxide blocks, includes but not limits to di-block co-polymers, tri-block co-polymers, or oligomers. The phenolic compound includes but not limits to resorcinol, catechol, and phloroglucinol.

The organic gel coating layer which encapsulates the active core is pyrolyzed at raised temperatures above 400° C. to form a layer of carbon with well-ordered nano-pores. The carbon coating layer is preferred to be several nanometers in thickness and amorphous or semi-graphitic in structure. The pore size in the carbon coating layer is preferred to be 2-50 nanometers.

According to another embodiment the disclosed method of preparation of silicon/graphene composite includes but not limits to chemical vapor deposition (CVD) of silicon nanoparticles onto graphene or graphene oxide surface. The silicon precursor is gaseous, includes but not limits to silane, and alkyl silanes. The size of the deposited silicon nanoparticles is preferred to be 2 nanometers to several hundred nanometers and the weight of Si is preferred to be 5-50% of total weight.

According to another embodiment the disclosed method of preparation of silicon/graphene composite includes but not limits to mechanical mixing of silicon particles and graphene or graphene oxide. The graphene or graphene oxide is preferred to have very high surface area and open structure. The silicon particles are preferred to be less than 100 nanometers in diameter. The weight of deposited Si is preferred to be 5-50% of total weight.

According to another embodiment the composite prepared from silicon and graphene oxide is heated above 500° C. with H₂/Ar mixed gas to thermally reduce graphene oxide to graphene with much improved electronic conductivity.

According to the embodiments disclosed in this invention the silicon oxide layer can be generated by oxidizing the silicon particles in a wet environment with, including but not limiting to, hot air, oxygen, and other oxidants. The silicon oxide layer is preferred to be 10-60% of the particle radius in thickness. The oxide layer is later etched away with hydrofluoric acid or a hydroxide base.

### EXAMPLES

The examples given are for illustration only and not intended to limit the specification or the claims in any manner.

### Example 1

### CVD Growth of Silicon Nanoparticles on Graphene Oxide

Deposition of silicon nanoparticles from its gaseous precursor can be achieved via various CVD related methods. The example described is by illustration only. 5.0 grams of graphene oxide was loaded in the middle of a quartz tube inside a tube furnace. The quartz tube was purged with Ar gas for two hours before the pressure was reduced to 5 mbar. The tube was heated up to 550° C. with 5% H₂/Ar mixed gases at flow rate of 25 sccm. When temperature is stabilized, the gas inlet is switched to 5% SH₄/Ar at flow rate of 25 sccm. The reaction was kept for 4 hours before the furnace is cooled down to room temperature with 5%H₂/Ar as protecting gas.

### Example 2

### Silicon Nanoparticles Embedded Inside Graphene Oxide by Mechanical Mixing

One gram silicon nanoparticles with average size of 10 nanometers and 5.0 grams graphene oxide was dispersed into 50 mL ethanol. The mixture was ultrasonicated for 4 hours before filtered. The black power was collected and dried under vacuum at 80° C. overnight. The collected solid was then transferred into a quartz tube inside a tube furnace and purged with Ar gas for 4 hours. Then the gas was switched to 5%H₂/Ar as the temperature of the furnace was raised to 650° C. and kept for 4 hours before the temperature was lowered to room temperature.

### Example 3

### Synthesis of Ordered Nano-Porous Carbon Coating on Si/Graphene Composite

2.7 grams phloroglucinol and 3.0 grams F127 were mixed and dissolved in water/ethanol solution (135 mL/15 mL) under constant stirring at room temperature before 4.0 grams formaldehyde was added to the solution. Then 0.6 gram of conc. hydrochloric acid was added and the solution was stirred until it becomes cloudy. 2.7 grams silicon/graphene powder was slowly added to the cloudy solution. The mixture was stirred overnight. All the solids were assembled into a gel ball and the solution is colorless. The gel ball was washed several times with water/ethanol, alternatively before dried under vacuum at 80° C. overnight. The dried composite was loaded in a quartz tube inside a tube furnace. The tube was first purged with N2 then was heated up to 650° C. with 5% H₂/Ar as protecting gases. The pyrolysis process was kept for 5 hours before the tube is cooled down to room temperature. The black solid was grinded, ball-milled, sieved and stored in Ar atmosphere for future us

The preferred embodiments of the present invention have been described in some details, the invention, however, is intended to be as broad as defined in the claims below. Those skilled in the art may be able to study the preferred embodiments and identify alternative ways to practice the invention differently from those described herein. Thus the described embodiment are illustrative only and are not limiting to the scope of this invention which is given to the claims below and any and all equivalents thereof.

The preferred embodiments of the present invention have been described in some details, the invention, however, is intended to be as broad as defined in the claims below. Those skilled in the art may be able to study the preferred embodiments and identify alternative ways to practice the invention differently from those described herein. Thus the described embodiment are illustrative only and are not limiting to the scope of this invention which is given to the claims below and any and all equivalents thereof.

What we claim:

1. High energy anode with an active core and a porous protecting shell.

2. The porous shell in claim 1 is carbon with well-ordered nano-pores.

3. The active core in claim 1 is silicon with an outside silicon oxide layer. The layer thickness is 20-60% of the radius of the silicon particle.

4. The active core in claim 1 can be a Si composite comprised with silicon particles and a flexible carbonaceous material with electron conducting ability.

5. The silicon oxide layer in claim 3 can be oxidized by oxidants including but not limiting to air, oxygen, and peroxides. The oxide layer can be removed by etching with an acid or a base. The silicon particle can be 2 nanometers up to micrometers

6. The silicon in claim 3 is preferred to be 5-80% of the total weight of the anode material.

7. The flexible material in claim 4 is graphene, graphene oxide, exfoliated graphite, reduced graphene oxides

8. The weight of the flexible material in claim 4 is preferred to be 20-80% of the weight of the composite; the weight of silicon particles is preferred to be 80-20%.

9. The silicon particle in claim 4 is preferred to be 2 to 200 nanometers.

10. The porous carbon coating in claim 1 is 10-80% of the total weight of the anode.

11. The nanopores in claim 2 are 2 to 50 nanometers in diameter.

12. The method of producing porous carbon layer in claim 2 is pyrolysis of a gel-like organic polymer composite with well-ordered domains.

13. The composite with well ordered domains in claim 12 comprises a co-polymer as a structural directing agent and a phenolic resin.

14. The co-polymer in claim 13 includes but not limits to di-block, tri-block, PEO-PPO type polymers.

15. The phenolic resin in claim 13 is prepared by a condensation reaction between formaldehyde and a phenolic compound.

16. The phenolic compound in claim 15 is phenol or its derivatives, including but not limiting to resorcinol, catechol, and phloroglucinol.

17. The Si composite with a flexible material in claim 6 is prepared by chemical vapor deposition (CVD) or method derived from CVD of gaseous silicon precursor on the flexible material.

18. The gaseous Si precursor in claim 17 is silane or alkyl silanes.

19. The Si composite with flexible material in claim 6 is prepared by mechanical mixing of silicon nanoparticles with the flexible material.
